(19) United States
(12) Patent Application Publication
(10) Pub. No.: US 2019/0122258 A1
(43) Pub. Date: Apr. 25, 2019

(54) DETECTION SYSTEM FOR IDENTIFYING ABUSE AND FRAUD USING ARTIFICIAL INTELLIGENCE ACROSS A PEER-TO-PEER DISTRIBUTED CONTENT OR PAYMENT NETWORKS

(71) Applicant: ADBANK INC., Wasaga Beach (CA)

(72) Inventors: Chiron Richard BRAMBERGER, Wasaga Beach (CA); Jonathan Michael GILLHAM, Collingwood (CA); Daniel Charles SHAPIRO, Ottawa (CA)

(21) Appl. No.: 16/168,231

(22) Filed: Oct. 23, 2018

Related U.S. Application Data
(60) Provisional application No. 62/575,879, filed on Oct. 23, 2017.

(51) Int. Cl. G06Q 30/02; G06N 3/08

(52) U.S. Cl. CPC G06Q 30/0248; G06K 9/6267; G06N 3/08

(57) ABSTRACT

A system and method for detecting and mitigating abuse and fraud on advertising platforms using artificial intelligence is disclosed, the system and method including a advertising platform built upon blockchain technologies storing records of transactions, and a discovery system that periodically audits records stored against website code and website image data to automatically identify suspicious transactions. The suspicious transactions are identified to establish a blacklist of identities who are then prevented from interacting with the blockchain technologies in respect of available transactions.

### CROSS REFERENCE

This application is a non-provisional of, and claims all benefit, including priority, to U.S. Application No. 62/575,879, entitled: DETECTION SYSTEM FOR IDENTIFYING ABUSE AND FRAUD USING ARTIFICIAL INTELLIGENCE ACROSS A PEER-TO-PEER DISTRIBUTED CONTENT OR PAYMENT NETWORKS, filed 23 Oct. 2017, incorporated herein by reference in its entirety.

### FIELD

Embodiments of the present disclosure generally relate to the field of machine learning platforms, and more specifically, embodiments relate to devices, systems and methods for abuse and fraud detection by an artificial intelligence-based discovery system for extracting website loading characteristics for heuristic classification.

### INTRODUCTION

Modern online advertising networks are built upon an assumption that the platform will police the network and honestly report pricing to participants in the network. The underlying trust problem between advertisers and publishers can be resolved using a public ledger employing blockchain technology, recording the transfer of value for all to see.

However, even with blockchain technology integrated into an advertising network, policing fraud and abuse by actors participating in an advertising network is not resolved. For example, advertisement publishers may collude to increase prices, or fraudulently claim to render advertisements on their website.

A challenge with effectively policing the network is the scope of potential malicious and fraudulent activities. In particular, an entirely human-based review is inefficient and impractical in view of detection and mitigation. Human-based reviewers suffer from fatigue and are unable to process the volume of advertisement placements.

### SUMMARY

Embodiments disclosed herein describe an automated system and method for detecting and mitigating several key abuse and/or fraud scenarios using artificial intelligence as a heuristic approach to generating automated classifications of suspected abuse and/or fraud.

Specific technical improvements are described in relation to using artificial intelligence and machine learning as a mechanism to identify potential fraud aspects. In further embodiments, a blockchain data structure is utilized in conjunction with the artificial intelligence and machine learning, the blockchain data structure stored on distributed ledgers maintained on a plurality of distributed computing systems. The blockchain data structure tracks and handles transactions of advertising purchases (e.g., an auction/reverse auction mechanism), storing information thereon that confirms the bidding activities as well as purported evidence of ad loading and ad hosting.

The blockchain data structure includes a consensus mechanism that is tied to one or more identities of the advertisers and the content hosting entities or publishers. The identities can be used to establish reputations which are developed over a period of time, as prior transactions are reviewed for potential fraudulent activity. Accordingly, the consensus mechanism, in a preferred embodiment, includes a determination of a reputation level associated with an identity or the presence of the identity on a whitelist/blacklist data structure in determining whether the identity is able to interact with the distributed ledger and the blockchain data structure stored thereon.

The neural network mechanism, in a preferred embodiment, periodically traverses the blockchain data structure and conducts automated (or semi-automated) reviews of transactions and transaction behavior. As described in various embodiments below, transactions (or a randomly selected subset thereof) may be automatically reviewed for suspicious rendering behavior (e.g., based on automated image viewport/webpage code analysis), suspicious loading behavior (e.g., repeated loading potentially indicative of bot loading or bot click-throughs), and/or suspicious auction bidding behavior (e.g., artificially bidding up prices, price collusion to reduce a price).

Using artificial intelligence to detect and flag common patterns of abuse and fraud resolves the problem of assuming trust in the advertising platform operator. An improved technical system using a combination of improved machine learning classification and a distributed ledger data structure across one or more computing nodes is described.

In some embodiments, the technical system is a special purpose computing device that includes at least a processor and computer memory that is adapted to provide a specific fraud detection functionality that refines itself over a period of time by updating a specially configured neural network.

The technical system provides an improved mechanism platform that operates in an “internet centric” world by, as described in various embodiments, automatically processing website code, image data, timestamped transactions, among others, to heuristically identify potential aspects of fraud.

The technical system operates in an environment having limited computer resources, and accordingly, the neural network is adapted for improved efficiency and accuracy in view of optimizing a confidence level of output through improved feature selection specifically adapted for tracking fraudulent (e.g., abusive) website behavior for rendering advertisements. A blacklist data structure is maintained based on tracked estimations of fraudulent behavior.

Fraudulent website behavior includes website behaviors or the use of malicious automated systems to falsify website advertisement rendering to artificially raise automatically tracked metrics of website usage and advertisement effectiveness. For example, an automated program (e.g., bot) may execute code which causes a website rendering tracking mechanism to count advertisements that are loaded off-screen, on top of one another, partially cut off, or resized, among others. Further, interactions with advertisements (e.g., click-throughs, auto-play/selective-play videos, hover-overs), among others, may also be falsified.

In a further embodiment, additional aspects of information are tracked and used as part of the feature space, including prior transaction data (e.g., prices, volumes, timestamps) to assess aspects of price collusion.

The system interoperates with a publicly distributed ledger such as a blockchain, storing transactional information (e.g., bidding activity) and other data payloads thereon (e.g., URL for a webpage, evidence of ad rendering), which can be adapted as additional aspects to include into a feature space for detecting advertisement fraud. Information stored in a public ledger and also information obtained from real-world observations, such as website rendering, can be combined to efficiently detect and mitigate fraud and abuse on a blockchain-based advertising network.

For example, the URLs can be traversed by the system to independently verify proper rendering to audit the advertisement transaction stored thereon, among others. Timestamps in addition to bidding activity may exhibit patterns of fraudulent behavior, and these may be added as additional features for incorporation into the feature space provided by the computing nodes of the neural network.

Bidding activity over time may exhibit patterns indicative of fraudulent behavior. Measurements of activity are taken at intervals, timestamped, and ordered into a time-series.

An automated system is described in various embodiments that provides a centralized fraud detection neural network that receives as electronic inputs website code features as well as a set of rendered image features.

A neural network is established where computing nodes represent specific features in a feature space, the nodes having weighted interconnections that represent the linkages between the features.

A series of technical problems are overcome by some embodiments of the system, including deriving computational approaches and mechanisms to improve accuracy of fraud detection while maintaining an efficient usage of computer resources, improving potential trust in the network through a periodic audit capability to automatically flag certain advertisement presentments as suspicious.

In a first aspect, there is provided a computing device for advertising fraud discovery including computer memory, the computing device comprising: a data storage configured for storing one or more data sets representative of a centralized fraud detection neural network; a processor configured to maintain the centralized fraud detection neural network stored on the data storage, the neural network comprising an interconnected set of computing nodes adapted as in one or more layers and a plurality of interconnections between computing nodes of the set of computing nodes, each computing node representative of a fraud detection feature and each interconnection representing a weight between computing nodes indicative of a relationship between the fraud detection features underlying the computing nodes, the fraud detection features including at least a set of website code features, and a set of image features, and an additional set of computing nodes representing a concatenated set of hybrid website and image features.

A first input receiver is configured to receive tokenized code segments of a website and to process the tokenized code segments to generate the set of input website code features through monitoring of token co-occurrence.

A second input receiver is configured to receive image data representing a full screen view or views presented to a user of the website and to process portions of the received image data to generate a set of input image features and classifications indicative of proportions of the received image data rendering at least two of: graphical advertisement, no graphical advertisement, or a non-functional website.

A third input receiver configured to receive text or image data representing an advertisement that should be displayed on the website.

These features are mapped to input nodes of the neural network, which has one or more layers of hidden nodes whose interconnections represent a trained neural network for generating classification scores (e.g., metrics representative of a confidence level in some embodiments) or classification outputs (e.g., binary outputs in some embodiments). In some embodiments, a further score is generated in relation to a reliability score, for example, based on a loss function indicating the system's confidence in the reliability of the estimated score (e.g., if the training set does not map well to the actual features received, the reliability may be low, and if the training set maps identically to the actual features received, the reliability may be high).

A merger layer engine (e.g., provided by the processor) is configured to merge the set of input website code features and the set of input image features to generate the concatenated set of hybrid website and image features.

The processor is configured to receive at least the set of website code features, the set of image features, the set of input hybrid website and image features, and the text or image data representing the advertisement that should be displayed on the website and generate a confidence metric representative of a classification conducted by the neural network that the advertisement is loaded and displayed on the website, and that the loading of the website was not originally requested by an automated process.

In another aspect, the fraud detection neural network is configured to maintain one or more computing nodes representative of prior renderings of the advertisement as a first set of additional fraud detection features.

In another aspect, the one or more computing nodes representative of the prior displays of the advertisement have weighted interconnections representative of one or more repetitive temporal loading patterns;

In another aspect, the one or more computing nodes representative of the prior displays of the advertisement are utilized in the generation of the confidence metric such that a presence of the one or more repetitive temporal loading patterns modifies the generated confidence metric.

In another aspect, responsive to any one of the weighted interconnections representative of the one or more repetitive temporal loading patterns being greater than a pre-defined threshold, the processor records the one or more repetitive temporal loading patterns having weighted interconnections greater than the pre-defined threshold on the data storage.

In another aspect, the fraud detection neural network is configured to maintain one or more computing nodes representative of prior prices of the advertisement as a second set of additional fraud detection features.

In another aspect, the one or more computing nodes representative of the prior prices of the advertisement have weighted interconnections representative of one or more repetitive temporal pricing patterns.

In another aspect, the one or more computing nodes representative of the prior displays of the advertisement are utilized in the generation of the confidence metric such that a presence of the one or more repetitive temporal pricing patterns modifies the generated confidence metric.

In another aspect, responsive to any one of the weighted interconnections representative of the one or more repetitive temporal pricing patterns being greater than a pre-defined threshold, the processor records the one or more repetitive temporal pricing patterns having weighted interconnections greater than the pre-defined threshold on the data storage.

In another aspect, the set of input hybrid website and image features are generated through one or more concatenations of individual input website code features of the set of input website code features with individual input image features of the set of input image features.

In another aspect, the set of input hybrid website and image features further include one or more concatenations of prior price features and one or more concatenations of prior website rendering features.

In another aspect, a number of the one or more concatenations is iteratively tuned utilizing a feedback loop to maintain a target confidence level.

In another aspect, the target confidence level is established based on a confusion matrix derived from training the fraud detection neural network on a training dataset, the confusion matrix including matrix values indicative of at least an expected probability of false positive, false negative, true positive, and true negative given the training dataset and the input feature set.

In another aspect, the centralized fraud detection neural network is a recurrent neural network; and the set of input hybrid website and image features is provided to the centralized fraud detection neural network in the form of a data structure configured to have a number of time series, a number of values per time step, and a number of time steps, and wherein the number of time series, the number of values per time step, and the number of time steps are tunable to modify characteristics of operation of the centralized fraud detection neural network.

In another aspect, the set of input image features include at least one of pixel colors, blob detection, edge detection, or corner detection.

In another aspect, the neural network includes at least a LSTM model for classifying the set of input website code features.

In another aspect, the neural network includes at least a CNN configured for image reshaping for classifying the set of input image features.

In another aspect, the computing device interoperates as a validation mechanism coupled to a distributed set of computing systems, each maintaining a cryptographic distributed ledger in accordance with a consensus mechanism for propagating and updating the cryptographic distributed ledger, the cryptographic distributed ledger storing records of advertising purchase transactions between advertising purchasing parties and advertising publishing parties and one or more data sets representative of the advertisement that should be displayed on the website.

In another aspect, transactions on the cryptographic distributed ledger are identified as malicious and non-malicious through provisioning of the one or more data sets representative of the advertisement and one or more data sets representative of the website as inputs into the arbitration mechanism.

In another aspect, the computing device only interoperates as an identification mechanism when the confidence metric is greater than a pre-defined confidence threshold.

In another aspect, the computing device interoperates as an identification mechanism when the confidence metric is greater than a pre-defined confidence threshold, and wherein a secondary manual arbitration mechanism is utilized as an arbitration mechanism when the confidence metric is equal to or less than the pre-defined confidence threshold.

In another aspect, the records stored on the cryptographic distributed ledger include data sets including at least one of a string identifying what country the advertisement was rendered, a string identifying a type of browser, a string identifying a type of operating system, a string indicating an operating system version, a string indicating product type, a string indicating a device manufacturer, a string indicating a web layout type; and the data sets are captured temporally proximate to when the advertisement was purchased and subsequently rendered.

In another aspect, the records stored on the cryptographic distributed ledger further include the set of website code features and the set of image features captured temporally proximate to when the advertisement was purchased and subsequently rendered.

In another aspect, upon a positive identification of a malicious advertisement, a corresponding publisher profile is added to a data structure storing a list of publisher profiles applied for exclusive filtering; the distributed set of computing systems utilize an acceptance protocol for gatekeeping acceptance of new blocks representing the advertising purchase transactions, the acceptance protocol adapted to automatically decline the acceptance of new blocks associated with any publisher profile residing on the list of publisher profiles.

### BRIEF DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein:

FIG. 1 displays a fraud-detection artificial intelligence system (“Discovery System”) interfacing with an Ethereum-based distributed peer-to-peer advertising network, according to some embodiments. The Discovery System analyzes records on the blockchain, the publisher's website, and an advertisement database to identify bad actors and malicious behavior.

FIG. 2 displays the Discovery System analyzing a rendering of the publisher's site and the advertisement database to verify that each ad that is supposed to be displayed is present on the site, according to some embodiments.

FIG. 3 displays the Discovery System analyzing a rendering of the publisher's site against the advertisement database to verify that each ad that is supposed to be displayed is actually visible to the user, and not obfuscated via overlapping or other techniques, according to some embodiments.

FIG. 4 displays the Discovery System analyzing transaction records on the blockchain to identify transaction patterns associated with fraud (such as price manipulation or collusion), according to some embodiments.

FIG. 5 displays the Discovery System examining patterns of mouse movement, or finger presses on a touchscreen, to identify malicious software that simulates the browsing patterns of a person, according to some embodiments.

FIG. 6 displays the Discovery System analyzing the source code of a publisher's site, a rendering of the publisher's site, and an advertisement database to identify source code patterns associated with fraud, according to some embodiments.

FIG. 7 displays the Discovery System analyzing user interaction with a form over time to identify unusual activity that may represent automated form-filling software, according to some embodiments.

FIG. 8 displays the Discovery System analyzing several renderings of the publisher's website over time to identify sudden and unusual changes in the content and appearance, which may be indicative of malicious activity targeting the publisher's website, according to some embodiments.

FIG. 9 displays the Discovery System analyzing the time and location of origin of traffic to a publisher's website to identify unexpected changes in the timing and location of origin of traffic, which may be indicative of artificial (paid) traffic, according to some embodiments.

FIG. 10 displays the Discovery System analyzing a rendering of a publisher's website to identify excessive pop-up and pop-under behavior that may be indicative of fraud on the part of the publisher or malicious activity targeting the publisher's website, according to some embodiments.

FIG. 11 displays the Discovery System analyzing a publisher's website to detect ads hidden in such a way that they display enough to trigger a payment from the advertiser, but not enough to be actually visible to the user, according to some embodiments.

FIG. 12 displays the Discovery System analyzing transaction records on the blockchain to identify transaction patterns involving unusually large rebates from publishers to other agents in the system, which may be indicative of kickback schemes, according to some embodiments.

FIG. 13 displays the Discovery System operating with a custom application to identify malicious software that generates fake install notifications to the advertiser, triggering fraudulent bonus payments, according to some embodiments. The custom application detects installations on the device and reports them to the discovery system, which compares those notifications to those recorded in the advertising database.

FIG. 14 displays the Discovery System examining the sequence of redirects that occur when attempting to access the publisher's website in order to identify excessive and fraudulent redirection that the user did not intend, according to some embodiments.

FIG. 15 displays a diagram of the distributed peer-to-peer advertising network with an artificial intelligence system analyzing a log of events that have led to a direct purchase or sale of a product or service to determine rewards for publishers who contributed to the purchase, according to some embodiments.

FIG. 16 displays a machine-learning process for categorizing businesses based on their names, using a tokenizer, a custom embedding, and a recurrent neural network, according to some embodiments.

FIG. 17 displays a machine-learning process for categorizing websites based on the HTML code used to render them, using a tokenizer, a custom embedding, and a recurrent neural network, according to some embodiments.

FIG. 18 displays a machine-learning process for identifying suspicious sites based on the HTML code of the website and the category of the website as determined using the process displayed in FIG. 17, according to some embodiments.

FIG. 19 displays a machine-learning process for counting the number of ads displayed on a website using a rendered image of the website, according to some embodiments. If the number displayed does not match the number expected, this may be indicative of fraud.

FIG. 20 displays a machine-learning process for identifying ad injection attacks on websites using the HTML code of the website and an image of the website rendered using the HTML code, according to some embodiments.

FIG. 21 displays a machine-learning process for identifying malicious cookies through analysis of the cookie string, according to some embodiments.

FIG. 22 displays a machine-learning process for identifying pages that target artificially high cost-per-click without providing value to the viewer, by analyzing a rendering of the publisher's site along with various cost-per-click statistics, according to some embodiments.

FIG. 23 displays a machine-learning process for identifying fraudulent traffic extension, also known as “traffic sourcing”, using the time-series record of ad requests generated by a publisher's site, according to some embodiments.

FIG. 24 displays a machine-learning process for identifying price manipulation activity, such as collusion, on an auction-based advertising network, using historical behavior, according to some embodiments.

### DETAILED DESCRIPTION OF THE FIGURES

The present invention is now described with respect to a specific embodiment thereof, wherein a distributed peer-to-peer advertising network built upon a cryptocurrency or tokens is used with a software module or modules that perform analysis of a plurality of factors, wherein said software attempts to detect a plurality of occurrences of various types of fraud. The software is implemented on physical computing hardware, including a processor and associated computer memory.

Of course, the invention(s) described herein are not restricted to a particular example, which will be described in what follows, but applies to other architectures possibly used to establish and provide a system and method of fraud detection using artificial intelligence built upon a blockchain based advertising network.

In a first embodiment, an artificial intelligence system is created upon and with access to an advertising network built upon a cryptocurrency and blockchain based system. The artificial intelligence system is configured to be trained, programmed, evolved, or otherwise brought into a state whereby the system is able to detect patterns of fraud as described in various embodiments herein. The training data is based upon known examples of both organic and fraudulent behavior of website visitors, advertisers, and publishers.

As described in various embodiments below, the artificial intelligence system is a discovery system is provided that interoperates with transaction records stored on the blockchain.

The discovery system operates as a verification crawler that periodically traverses the records stored on the blockchain, which record transactions of digital advertisement hosting/loading on various publisher websites. The discovery system crawls through the blockchains to run transaction records through one or more specially configured and trained neural networks, which attempt to flag transactions as potentially fraudulent or not fraudulent. In some cases, a single neural network is utilized that is adapted generally for fraudulent activities. In some embodiments, specialized neural networks are trained for specific types of fraud and the use of specialized feature sets, which can be run in parallel (e.g., on different threads of a same processor, or multiple processors, or different devices entirely) to establish an aggregate estimated fraud score. Where specialized neural networks are utilized, a first neural network is configured to assess website code and image data against the desired advertisement's data (e.g., to track malicious pop-over/pop-under/click injection/resizing), a second neural network is configured to traverse one or more other transactions by the same user as extracted from the blockchain (e.g., for pattern assessment showing patterns in timing that may be indicative of fraud), and a third neural network is configured to traverse one or more transactions by other transactions by other users in respect of the desired advertisement (e.g., to assess patterns of collusion between different users, such as in a bidding process).

The discovery system, in some embodiments, is configured to retrieve or receive evidentiary information of the hosted advertisements, which is provided either through a resource locator (e.g., URL) embedded in the transaction records, or evidentiary information directly stored within the transaction records (e.g., JPGs). Where the transaction records include a resource locator, a separate crawler mechanism may be provided to periodically archive snapshots of the website code and an image of the website as loaded either when the transaction record is added to the blockchain or at a time proximate thereof, such that a contemporaneous record may be used for further verification by the verification crawler. The snapshots may be stored in data storage for later retrieval. In some embodiments, payments for hosting advertisements are released in accordance with logic associated with the discovery system (e.g., after validation indicating no fraud, the system automatically releases funds to an account associated with the user).

Where the discovery system, through the neural network, identifies potential fraud, the user account may be flagged for inclusion in a blacklist data structure. The blacklist data structure is a reference data structure that is used to either prevent payouts or to prevent the user from future interactions with the blockchain. For example, the blacklist data structure may be referred to during block propagation across the distributed ledgers, and transactions from users whose identifiers are on the blacklist data structure may barred from propagation across the distributed ledgers. To improve efficiency of the system at the cost of accuracy and coverage, in some embodiments, the discovery system only reviews a randomized sample of the transaction records.

In other embodiments, the discovery system is attuned to establish a reputation level for user accounts, which increases upon transaction records passing verification, or decreases upon failing verification. If the reputation level falls below a threshold, the user account can be blacklisted. The reputation level may also be utilized for probabilistically assessing whether a record should be analyzed as a sample (e.g., no reputation or low reputation transactions may be reviewed at a higher rate than high reputation transactions), to speed up the verification process.

The neural network, in an embodiment, includes input nodes representing several different feature sets, including website code tokens (e.g., tokenized based on div tags), website image portions, a hybrid set of inputs generated by concatenating website code tokens and image portions, and data representing the advertisement of interest, which are provided through one or more receiver components (which may be separate receivers in some embodiments, or a single receiver, in other embodiments). One or more layers of hidden nodes are utilized to establish relationships between inputs and outputs, and the number of hidden nodes may be modified, for example, to prevent overfitting to the training set and to maintain a level of generalization and transferability in relation to new inputs.

In some further embodiments, the neural network includes further input nodes relating to temporally related transactions associated with a particular advertisement (e.g., for bidding collusion recognition with other users), or further input nodes relating to other transactions by the same user (e.g., for temporal pattern recognition).

While the transaction records may be stored in a decentralized manner, in some embodiments, the neural network is hosted on a centralized server which is configured to periodically audit the transaction records. While in some embodiments the transaction records themselves are publicly available, the classification scores, the configuration, and the outputs of the neural network are not exposed to reduce the ability for malicious parties to adapt to the mechanism of the neural network. This is particularly important as a sufficiently large number of transactions are reviewed as the underlying mechanism of the neural network can otherwise be approximated or reverse engineered by a sufficiently motivated party if the outputs of the neural network are available.

Furthermore, in a further embodiment, a human reviewer may be tasked with reviewing borderline determinations, which are provided back into a training set as labelled data for periodic retuning of the neural network.

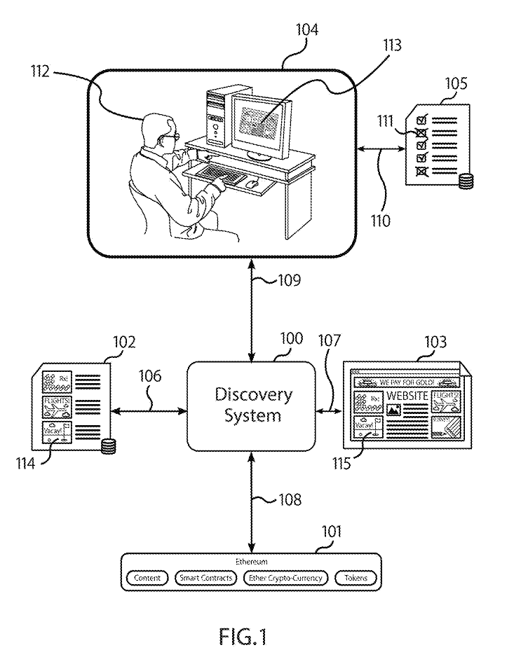

FIG. 1 displays a token-based distributed peer-to-peer advertising network platform, built upon the Ethereum blockchain 101, which is made up of the data and content layers, smart contracts, and tokens data store. Ethereum is provided as an example, and other distributed public ledgers are possible. In some embodiments, private (e.g., permissioned) ledgers can also be used.

The blockchain 101, in a preferred embodiment, includes smart contracts which are implemented with specific logic which determines how and whether interactions are possible in respect of the data stored thereon. Example interactions include an advertising entity (advertiser) posting requests for advertisement display, a content hosting entity (publisher) accepting the request, and the transfer of cryptocurrency or tokens from the advertiser to the publisher in return for the display of the advertisement.

The system also contains a Discovery System 100, which contains a suite of artificial-intelligence-powered logical subsystems that are used to identify fraudulent activity performed by actors involved in the interactions managed by the smart contracts.

The discovery system 100 includes input receivers that are components implemented by the processor that are configured to receive elements of information, for example, in relation to tokenized code segments, images of the website loading (in some embodiments, actively pulled by the discovery system based on embedded links stored in a blockchain transaction being reviewed, or in another embodiment, stored on the blockchain as extracted and archived at or proximate to the time of the transaction as a record of the transaction), and information representing what an ad being loaded should look like (e.g., what the discovery system 100 is matching against).

The input receivers map these inputs to input nodes of a neural network, which then represent some or all of the features being analyzed by the neural network. As described in various embodiments, a potential improvement may be provided through a merger layer engine that is implemented by the processor that generates additional features for analysis, which are merged features that operate on a concatenation of the website and image features to establish a hybrid feature set.

The hybrid feature set is established to expand the set of features being analyzed, and is a concatenation various website and image features. In some embodiments, all website features and image features are concatenated with one another, and in another embodiment, only a randomly selected subset of features are concatenated against one another. The hybrid feature set is particularly useful in improving system accuracy and speed relative to an implementation without using the hybrid feature set established by the concatenation of website code tokenized segments and image features.

In various embodiments, additional features sets are established through a traversal of the blockchain to identify previous transactions by the same entity or the same advertisements. For example, if the blockchain stores data objects in relation to prior loadings of an advertisement, an additional feature space inserted into the neural network may include these aspects for a determination of fraudulent or abusive. In relation to other loadings, the prior loadings of the same advertisement by the same entity may indicate a pattern of bot-induced/automated repetitive loading to increase loading counts. Similarly, if the feature space also includes characteristics of other transactions by the same entity (but for different advertisements), improved pattern recognition can be utilized to track repetitive patterns between different loadings, which are indicative of automated behavior.

The system additionally contains an advertisement database 102, which contains images, logs, or other information related to a particular advertisement 114; a system for delivering reports of potential fraudulent activity to a reviewer 112; and finally a database 105 of entities in the network that have been flagged as engaging in fraudulent behavior, which operates as the reference blacklist described above.

In a preferred embodiment the logical conditions required for the interaction to proceed include ensuring that the identity of an entity seeking to participate in the interaction is not on the reference identity blacklist 105.

The Discovery System 100 uses three sources of information to evaluate potential fraudulent activity: the distributed public ledger and smart contracts 101, the advertisement database 102, and the publisher's website 103. The Discovery System 100 uses non-obvious connections between the three, which would be difficult for a human to discover, to identify potentially fraudulent behavior.

In this embodiment, when potentially fraudulent behavior is detected, the Discovery System 100 generates a report 113 that is reviewed by a reviewer 112. If the reviewer identifies the activity as fraudulent, then the reviewer sends an update 110 to the database of fraudulent entities 105 that adds a record 111 that identifies the entities involved in the fraudulent activity.

In some embodiments, the Discovery System 100 may generate update 110 directly, in cases where there is sufficient confidence in the Discovery System's analysis of this particular scenario, and there is sufficient confidence in the Discovery System's ability to avoid false positives.

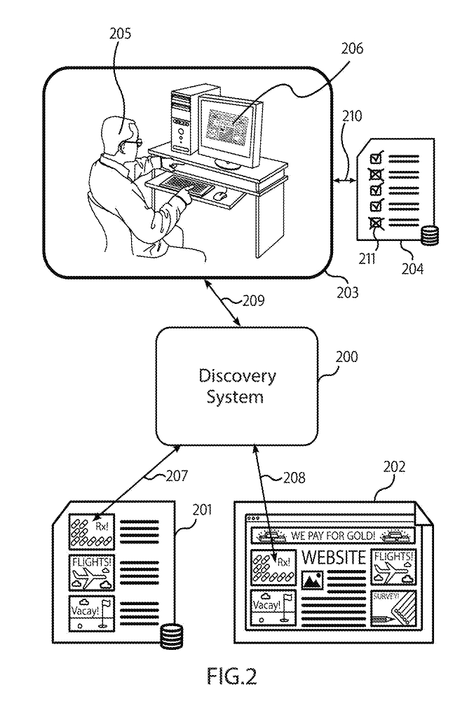

FIG. 2 displays the Discovery System 200 verifying that the advertisements displayed on a publisher's website 202 match the expected advertisements as recorded in the advertisement database 201. In this embodiment of the fraud detection system, the Discovery System 200 compares images of the advertisement as recorded in the advertisement database 201 to a rendered image of a publisher's website 202.

In some embodiments the advertisement database 201 may include references to the distributed public ledger 101 that allow the Discovery System 200 to leverage the smart contract information as an additional set of features.

This image matching is conducted to ensure that every ad that was supposed to be displayed on the publisher's website 202 is present, thus avoiding a form of advertisement fraud, referred to as display fraud, whereby images are loaded but not presented to the viewer, which generates a payout to the publisher despite generating no value for the advertiser.

In this embodiment, when potential display fraud activity is detected, the Discovery System 200 generates a report 206 that is reviewed by a reviewer 205. If the reviewer identifies the activity as fraudulent, then the reviewer sends an update 210 to the database of fraudulent entities 204 that adds a record 211 that identifies the entities involved in the fraudulent activity.

In some embodiments, the Discovery System 200 may generate update 210 directly, in cases where there is sufficient confidence in the Discovery System's analysis of this particular scenario, and there is sufficient confidence in the Discovery System's ability to avoid false positives. Confidence in the Discovery System's accuracy can, for example, be measured during training through the use of a confusion matrix or other metrics is above a particular threshold.

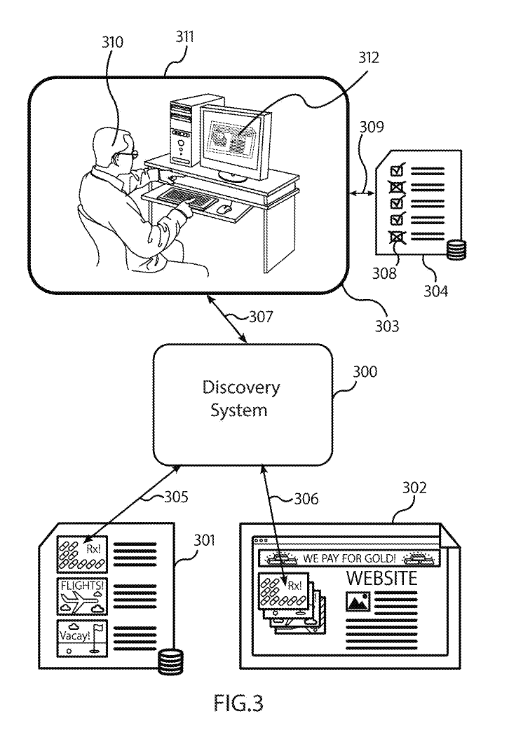

FIG. 3 displays the Discovery System 300 scanning a publisher's website 302 for advertisements obfuscated via overlapping of images. Although the advertisements are technically present, they are not presented in a way that creates value for the advertiser. This form of fraud is known as “image stacking”.

In this embodiment of the fraud detection system, the Discovery System 300 compares a rendering of the publisher's website 302 to the expected advertisements as recorded in the advertisement database 301.

The utilization of the website image, either stored at the time or proximate to the loading, or obtained after through crawling to the website, are useful in tracking this type of fraud. In particular, including them as part of the feature space allows for similar loadings tracked on the blockchain to indicate that a same or similar website image was used for multiple different transactions, which is a likely indication of abusive image stacking.

Additionally, in some embodiments the Discovery System 300 can scan the HTML Document Object Model (DOM) of the publisher's website to leverage additional information such as the location and sizing rules applied to images displayed on the page. The location and sizing rules applied to images displayed on the page can, for example, be extracted from a transaction record stored on the blockchain. An example of a suspicious image would be one that is expected to have a banner size (e.g., 400×100 pixels), but rather shows up as a 1×1 pixel image, etc. as formatted within the DOM. Similarly, the DOM elements are tokenized in some embodiments and used as features for analysis, and a trained neural network is able to use the DOM elements to identify and categorize suspicious image sizing of hosted advertisements. For example, in an embodiment, DOM elements are extracted from website frame sizing, and may be tokenized based on div tag elements, etc., or sub-elements thereof.

In this embodiment, when potential image stacking fraud is detected, the Discovery System 300 generates a report 312 that is reviewed by a reviewer 310. If the reviewer identifies the activity as fraudulent, then the reviewer sends an update 309 to the database of fraudulent entities 304 that adds a record 308 that identifies the entities involved in the fraudulent activity.

In some embodiments, the Discovery System 300 may generate update 309 directly, in cases where there is sufficient confidence in the Discovery System's analysis of this particular scenario, and there is sufficient confidence in the Discovery System's ability to avoid false positives.

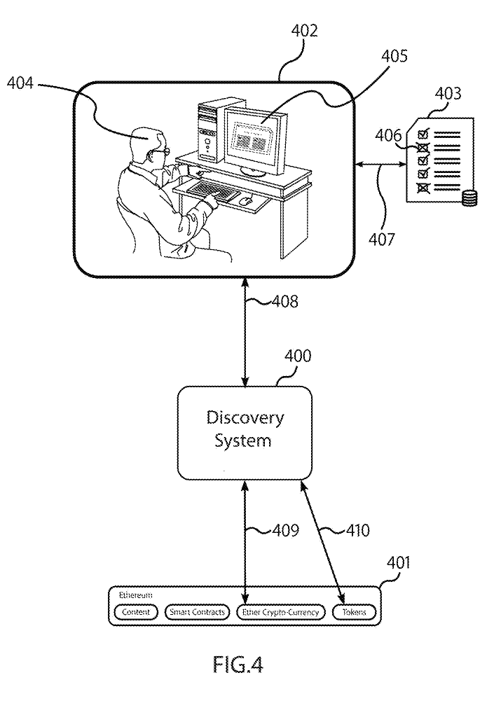

FIG. 4 displays the Discovery System 400 scanning transactions recorded on the distributed public ledger 401 for fraudulent activity such as price manipulation or collusion. In an embodiment specific to the Ethereum blockchain, the Discovery System 400 uses system call 409 to examine the Ethereum blockchain and system call 410 to examine transactions of tokens as exposed by specifically programmed elements of an Ethereum contract that exposes token transaction information.

The transactions are stored in one or more transaction records, and the transaction records themselves include information associated with the identity of the users who are parties to the interaction, records of the target advertisement to be hosted, records of interactions thereof with the target advertisement, and a record locator associated with timestamped evidence of the loading of the advertisement. In some embodiments, the record locator is a pointer to a webpage which can be loaded dynamically by a crawler reviewing historical records. The crawler can either obtain them on-demand, or store them at a time proximate to the transaction such that a temporally proximate snapshot of webpage code and webpage images is obtained.

In another embodiment, the snapshot of webpage code and images are provided by one of the parties in inclusion into the block noting the transaction.

As the neural network may or may not crawl various records, and the users do not know in advance how the neural network is tuned or targeting, the system is more effective in avoiding users “gaming” the system.

Crawls of historical transactions may occur more than once as the neural network is adapted, such that transactions that were not flagged before can be flagged, or vice versa. In some embodiments, transactions up to a particular pre-defined time in the past can be crawled and analyzed. In some embodiments, different neural networks are each tuned to a different type of fraud and used in parallel or sequentially such that transactions can be analyzed by multiple networks (e.g., operating independently or in parallel) such that an aggregate score can be established. If a human reviewer is utilized as a secondary analysis approach, the outputs may be used for reinforcement learning of the neural network (e.g., a neural network attuned to the specific type of fraud).

A technical advantage of such an approach is to establish an uncertainty level in situational awareness for potential malicious parties. Relative to other approaches where malicious parties are able to probe for weaknesses by observing patterns, the underlying fraud detection mechanism described in various embodiments herein modifies how the system reacts and responds to observed data and information.

The neural network provides a non-static approach that is less easily overcome (e.g., compare against IP-based blockers that are overcome with the use of VPNs and spoofed IP addresses). Furthermore, the system described in various embodiments does not operate in relation to any fixed relationships, and thus a malicious party is not able to easily define the metes and bounds of fraud before it is detected.

By examining historical transaction records, the Discovery System 400 can learn patterns typical of particular entities and the marketplace as a whole, and can therefore distinguish transaction patterns that deviate unusually from the norm, which may be indicative of collusion or manipulation. Each of the records are associated with parties to the transaction, and publishers can be blacklisted, as noted below.

In this embodiment, when potential fraudulent behavior is detected, the Discovery System 400 generates a report 405 that is reviewed by a reviewer 404. If the reviewer identifies the activity as fraudulent, then the reviewer sends an update 407 to the database of fraudulent entities 403 that adds a record 406 that identifies the entities involved in the fraudulent activity.

In some embodiments, the Discovery System 400 may generate update 407 directly, in cases where there is sufficient confidence in the Discovery System's analysis of this particular scenario, and there is sufficient confidence in the Discovery System's ability to avoid false positives.

The records 406 can be utilized by the blockchain in assessing whether an entity is capable of interacting with the blockchain. For example, the blockchain may have block/activity propagation mechanisms that include logic to reject new transactions associated with the entities noted on records 406. Accordingly, while a new block including transactions from the users associated with records 406 can be submitted, either the whole block or part of the block is rejected and thus the transaction is not added to the ledger.

In an embodiment, periodic payouts are generated based on transaction records, and accordingly, a user having a record 406 may not be able to obtain future payouts as the user cannot interact meaningfully with the blockchain. In some embodiments, records 406 are used for secondary processing by another system or a human before the user identity is blacklisted.

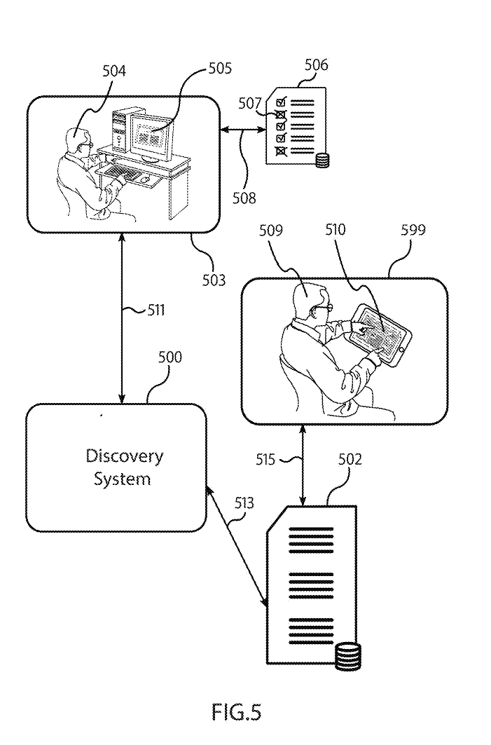

FIG. 5 displays the Discovery System 500 examining patterns of mouse movement, or finger presses on a touchscreen, to identify malicious software that simulates the browsing patterns of a person. The Discovery System 500 accesses a database 502 which contains the information gathered by mouse click and touch events generated by user 509 on the publisher's website 510. These records are annotated with the time at which they occurred, as well as other relevant details, such as the location of a mouse click. These records indicate how the advertisement was interoperated with.

By analyzing the sequence of events over time generated by typical users, the Discovery System can learn what kinds of patterns are typical for visitors to the website, and identify atypical patterns that may be indicative of software designed to mimic a human visitor. Such software is often used by “bot farms” to simulate traffic and generate payouts to a publisher without generating value for the advertiser.

In this embodiment, when potential bot activity is detected, the Discovery System 500 generates a report 505 that is reviewed by a reviewer 504. If the reviewer identifies the activity as fraudulent, then the reviewer sends an update 508 to the database of fraudulent entities 506 that adds a record 507 that identifies the entities involved in the fraudulent activity.

In some embodiments, the Discovery System 500 may generate update 508 directly, in cases where there is sufficient confidence in the Discovery System's analysis of this particular scenario, and there is sufficient confidence in the Discovery System's ability to avoid false positives.

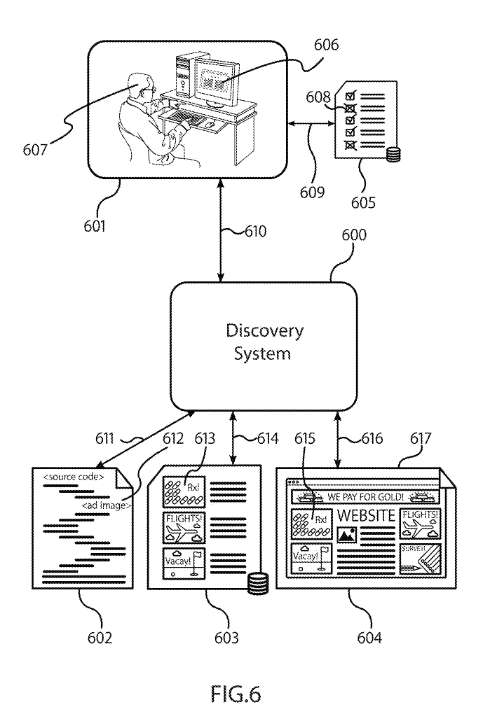

FIG. 6 displays the Discovery System 600 analyzing the source code of a publisher's site 602, a rendering of the publisher's site 604, and an advertisement database 603 to identify source code patterns associated with fraud. The code is analyzed both generally for code patterns associated with fraudulent websites, as well as specifically for fraudulent code associated with delivery of advertisements, as example 612 illustrates.

This information is compared to ads in the database 603 such as example ad 613 and finally compared to the rendered image of the publisher's website 604 such that example ad 615 is compared to both ad 613 in database 603 and the source code of the publisher's website 612.

By examining the relationships between these features for known well-formed and known not well-formed websites, the Discovery System 600 learns to distinguish between the two.

In this embodiment, when potential bot activity is detected, the Discovery System 600 generates a report 606 that is reviewed by a reviewer 607. If the reviewer identifies the activity as fraudulent, then the reviewer sends an update 609 to the database of fraudulent entities 605 that adds a record 608 that identifies the entities involved in the fraudulent activity.

In some embodiments, the Discovery System 600 may generate update 609 directly, in cases where there is sufficient confidence in the Discovery System's analysis of this particular scenario, and there is sufficient confidence in the Discovery System's ability to avoid false positives.

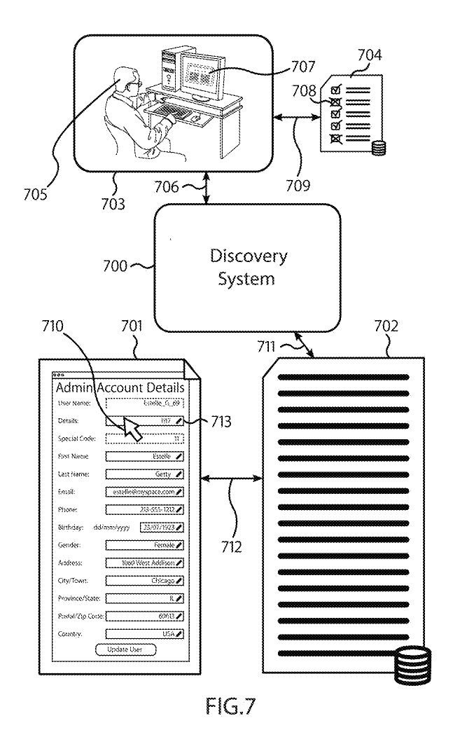

FIG. 7 displays the Discovery System 700 displays the Discovery System analyzing user interaction with a form over time to identify unusual activity that may represent automated form-filling software.

This activity is usually a level of user engagement that is highly valued by advertisers and thus generates valuable payouts to publishers. Faking this kind of activity using cheap software is therefore a highly attractive form of fraud that can quickly generate very high earnings for the publisher.

To identify this behavior, the Discovery System 700 uses information from database 702, which contains a log of user interactions with a form as illustrated in 701, an example interaction being mouse click 710. The interaction records are annotated with timing information such that the Discovery System 700 can analyze them as a time-series. By examining time-series representing known natural and fraudulent behavior, the Discovery System can learn to distinguish between the two scenarios.

In this embodiment, when potential bot activity is detected, the Discovery System 700 generates a report 706 that is reviewed by a reviewer 705. If the reviewer identifies the activity as fraudulent, then the reviewer sends an update 709 to the database of fraudulent entities 704 that adds a record 708 that identifies the entities involved in the fraudulent activity.

In some embodiments, the Discovery System 700 may generate update 706 directly, in cases where there is sufficient confidence in the Discovery System's analysis of this particular scenario, and there is sufficient confidence in the Discovery System's ability to avoid false positives.

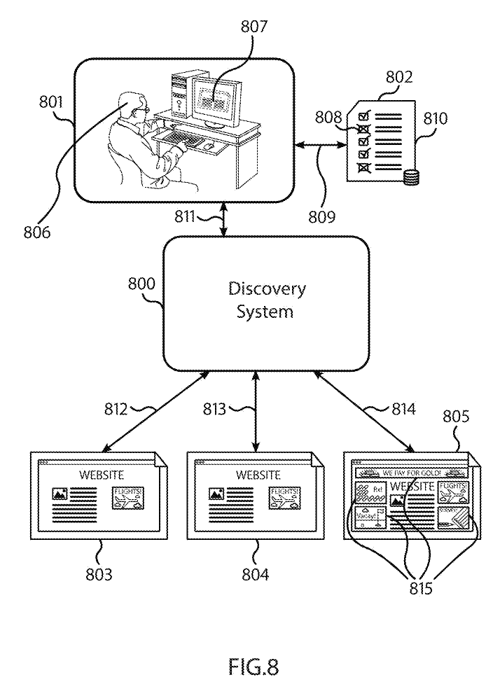

FIG. 8 displays the Discovery System 800 analyzing the most recent version of a publisher's website 805 against one or more stored previous versions of the publisher's website 803 and 804 to identify radical departures in the layout, content, and advertising placement of the publisher's website. Only three versions of the website are displayed, but in principle any number of previous versions may be stored and used.

Radical departures in the layout, content, and advertising placement of the publisher's website may indicate that the publisher is engaging in some form of fraud. It may also indicate that an attacker has modified the publisher's site to inject their own content and/or advertisements, e.g. through cross-site scripting, in order to profit from the publisher's traffic while compromising the site's integrity. This behavior is illustrated by the presence of additional advertisements 815 that were not present in the previous versions 803 and 804.

In this embodiment, when a problematic site is detected, the Discovery System 800 generates a report 807 that is reviewed by a reviewer 806. If the reviewer identifies the site as fraudulent or compromised, then the reviewer sends an update 809 to the database of fraudulent entities 802 that adds a record 810 that identifies the entities involved in the fraudulent activity.

In some embodiments, the Discovery System 800 may generate update 809 directly, in cases where there is sufficient confidence in the Discovery System's analysis of this particular scenario, and there is sufficient confidence in the Discovery System's ability to avoid false positives.

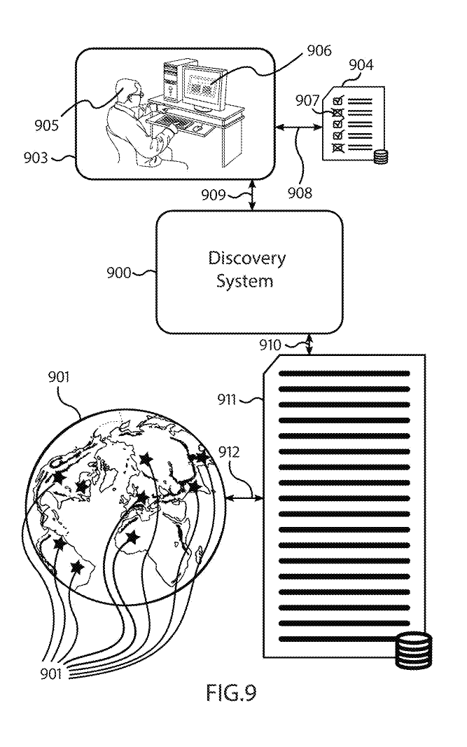

FIG. 9 displays the Discovery System 900 using records in a database 911 populated with information about advertisement requests, including but not limited to geographical information about the origin of the request and the time at which it was made.

This information is used to identify a form of fraud whereby publishers who are not generating traffic that was promised as part of a particular advertising deal or campaign will purchase fake traffic in order to boost their numbers to the levels specified in the advertising agreement. This often results in a spike in inbound traffic from a particular region or regions 901. This often also results in unnatural temporal traffic patterns, such as unusually high traffic outside of normal peak hours.

Therefore, the Discovery System 900 uses the information from database 911 to identify any unusual and unnatural changes in the timing and location of requests are present, which may be indicative of this kind of fraud.

In this embodiment, when potential fraudulent behavior is detected, the Discovery System 900 generates a report 906 that is reviewed by a reviewer 905. If the reviewer identifies the activity as fraudulent, then the reviewer sends an update 908 to the database of fraudulent entities 904 that adds a record 907 that identifies the entities involved in the fraudulent activity.

In some embodiments, the Discovery System 900 may generate update 908 directly, in cases where there is sufficient confidence in the Discovery System's analysis of this particular scenario, and there is sufficient confidence in the Discovery System's ability to avoid false positives.

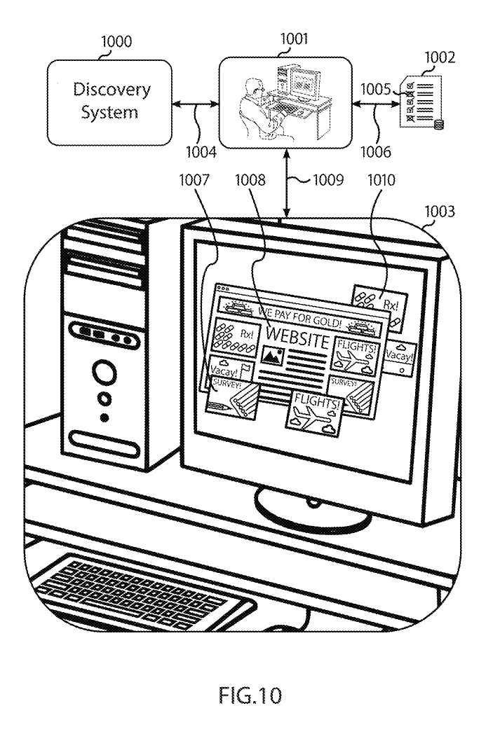

FIG. 10 displays the Discovery System 1000 analyzing a publisher's site using a specially modified web browser that is able to monitor and report on the loading of pop-ups as illustrated in 1003.

The Discovery System 1000 uses this information to detect a particular form of fraud whereby ads are loaded into pop-ups such that they generate revenue for the publisher but are never actually seen by the visitor. This is particularly problematic in the case of “pop-unders”, which are pop-ups that load under the publisher's site 1008, as exemplified by 1010.

In this embodiment, when potential fraudulent behavior is detected, the Discovery System 1000 generates a report 1004 that is reviewed by a reviewer as shown in 1001. If the reviewer identifies the activity as fraudulent, then the reviewer sends an update 1006 to the database of fraudulent entities 1002 that adds a record 1005 that identifies the entities involved in the fraudulent activity.

In some embodiments, the Discovery System 1000 may generate update 1006 directly, in cases where there is sufficient confidence in the Discovery System's analysis of this particular scenario, and there is sufficient confidence in the Discovery System's ability to avoid false positives.

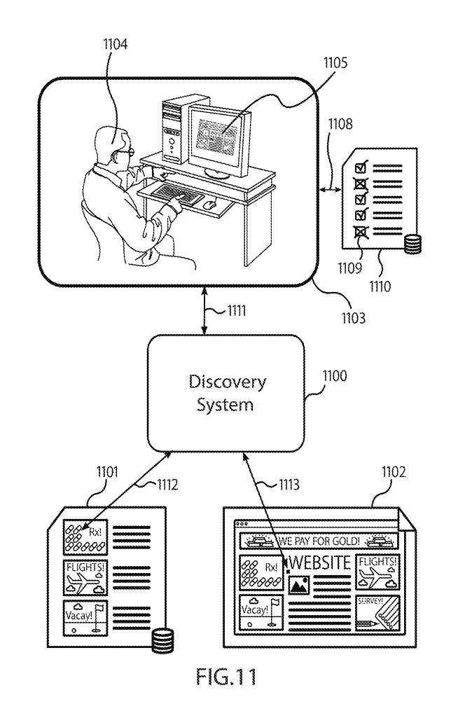

FIG. 11 displays the Discovery System 1100 comparing a rendering of a publisher's website 1102 against an advertisement database 1101 to identify scenarios where an advertisement is displayed at a size or resolution that is too small to be seen by the average web user. Such advertisements generate revenue for the publisher without generating any value for the advertiser.

The size and resolution are input as features extracted from the website code, by crawling through the DOM tree of the website.

In this embodiment, when potential fraudulent behavior is detected, the Discovery System 1100 generates a report 1105 that is reviewed by a reviewer 1104 as shown in 1103. If the reviewer identifies the activity as fraudulent, then the reviewer sends an update 1108 to the database of fraudulent entities 1110 that adds a record 1109 that identifies the entities involved in the fraudulent activity.

In some embodiments, the Discovery System 1100 may generate update 1108 directly, in cases where there is sufficient confidence in the Discovery System's analysis of this particular scenario, and there is sufficient confidence in the Discovery System's ability to avoid false positives.

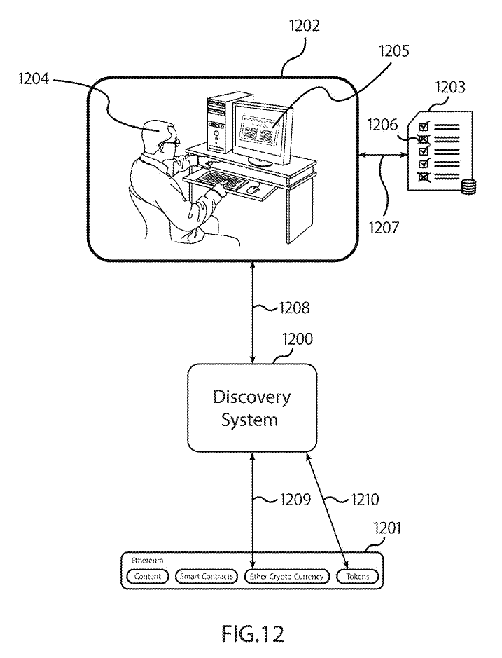

FIG. 12 displays the Discovery System 1200 analyzing historical transaction records on the distributed public ledger 1201 to identify a particular form of fraud known as “kickback fraud”.

In this form of fraud, advertising networks give payments (kickbacks) to other advertisement agencies as rewards for engaging the network in specific ways, such as engaging specific types of media or technologies. These payments are often kept secret from advertisers even though, as the final customers, they are ultimately the ones that are paying for these kickbacks. These payments are often kept secret from advertisers even though, as the final customers, they are ultimately the ones that are paying for these kickbacks.

Through training on manually curated examples of transaction histories associated with kickbacks, the Discovery System 1200 can learn connections and correlations between transactions that are indicative of kickback activity.

In this embodiment, when potential kickback activity is detected, the Discovery System 1200 generates a report 1208 that is reviewed by a reviewer 1204 as shown in 1202. If the reviewer identifies the activity as fraudulent, then the reviewer sends an update 1207 to the database of fraudulent entities 1203 that adds a record 1206 that identifies the entities involved in the fraudulent activity.

In some embodiments, the Discovery System 1200 may generate update 1207 directly, in cases where there is sufficient confidence in the Discovery System's analysis of this particular scenario, and there is sufficient confidence in the Discovery System's ability to avoid false positives.

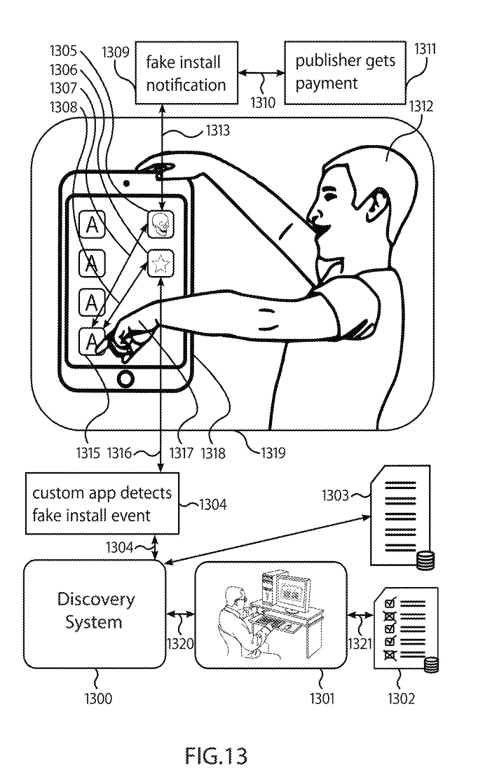

FIG. 13 displays the Discovery System 1300 interacting with a custom application 1306 to identify a complex form of fraud known as “click injection”, which typically targets mobile devices such as smartphones and tablets but can also be performed on personal computers, servers, smart watches, or other devices. Some embodiments described focus on the mobile ecosystem to explain the attack, but this does not limit the scope of the embodiments.

In this form of fraud, the attacker publishes a malicious app 1305 that appears to be legitimate—usually something simple, small, generic, and easy to implement. However, in addition to this functionality, this app listens or polls for the installation of other apps 1315 on the user's device 1318. If the installed app has participated in an advertisement campaign for the newly installed app, it can generate a fake click from the user. Then, when the user opens the new app, the installation of the app appears to be in response to the click generated by the app, which results in a large payout to the attacker.

To combat and identify this form of fraud, a custom app 1306 is used which also listens for installs and examines the activity of other apps in response to the install. Suspicious activity is reported to the Discovery System 1300, which compares it to a database of known legitimate and fraudulent activity 1303.

In this embodiment, when potential click injection activity is detected, the Discovery System 1300 generates a report that is reviewed by a reviewer as shown in 1301. If the reviewer identifies the activity as fraudulent, then the reviewer sends an update 1321 to the database of fraudulent entities 1302 that adds a record that identifies the entities involved in the fraudulent activity.

In some embodiments, the Discovery System 1300 may generate update 1321 directly, in cases where there is sufficient confidence in the Discovery System's analysis of this particular scenario, and there is sufficient confidence in the Discovery System's ability to avoid false positives.

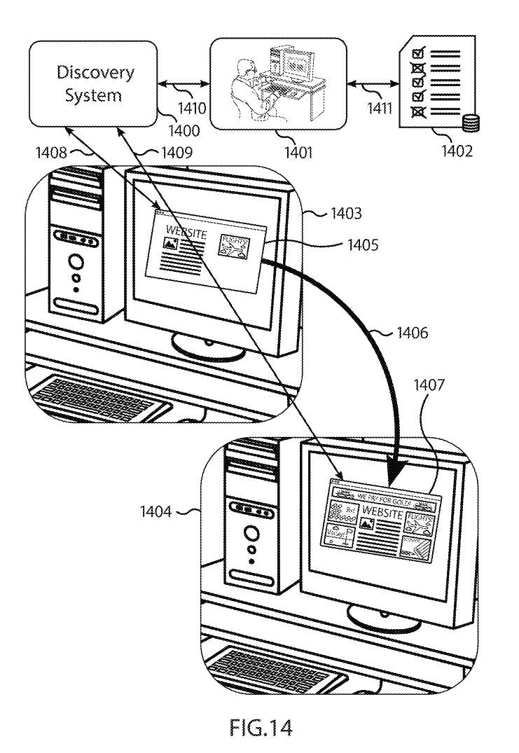

FIG. 14 displays the Discovery System 1400 interacting with a specially modified web browser that reports redirect information in order to identify a form of fraud known as “auto-redirect click fraud”.

This form of fraud seeks to capitalize on the payouts from affiliate links and advertisement clicks. The publisher's website 1405 contains code that generates fake clicks on an advertisement or automatic redirects (hence the name) that drive the user to the advertiser's website 1407 without their consent, either in response to an action or (more commonly) immediately on page load. This can be the result of fraudulent activity by the publisher, or the result of code injected through cross-site scripting by a malicious third party.

In some embodiments, the Discovery System 1400 identifies this activity by loading the publisher's website into a specially modified browser that reports when a redirect 1406 occurs. The Discovery System then analyzes the event to determine whether this is a legitimate redirect (e.g. redirect to mobile site, redirect to new domain) or fraudulent behavior.

In this embodiment, when potential fraudulent activity is detected, the Discovery System 1400 generates a report that is reviewed by a reviewer as shown in 1401. If the reviewer identifies the activity as fraudulent, then the reviewer sends an update 1411 to the database of fraudulent entities 1402 that adds a record that identifies the entities involved in the fraudulent activity.

In some embodiments, the Discovery System 1400 may generate update 1411 directly, in cases where there is sufficient confidence in the Discovery System's analysis of this particular scenario, and there is sufficient confidence in the Discovery System's ability to avoid false positives.

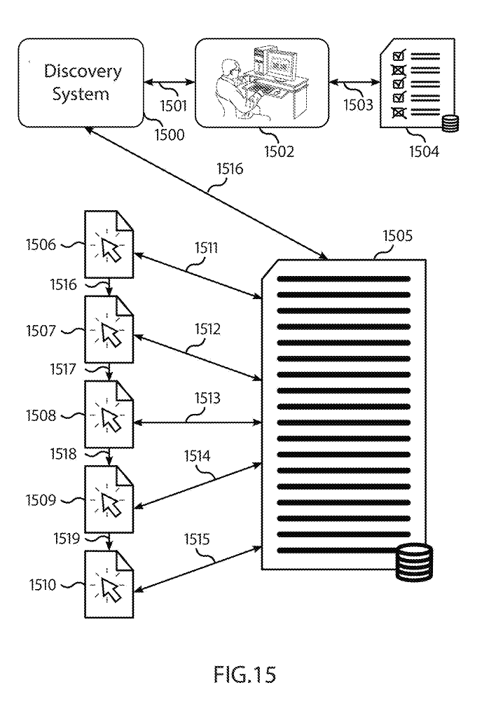

FIG. 15 displays the Discovery System 1500 analyzing a log of an individual user's browsing and purchasing activity 1505 to identify a particular and complex form of fraud, where software is used to create the illusion of a high-value customer.

Under normal circumstance, interactions with websites 1506, 1507, 1508, 1509, and 1510 represent a user browsing through a sequence of links. If all of these interactions are focused on a particular product or topic related to the product, then they become a very high value target for advertisements relating to the purchase of a product. Accordingly, advertisements shown to such users generate higher payouts than normal.

This leads to a sophisticated version of bot-based traffic fraud, where the bots are programmed to interact with sites in a way that mimics a high-value customer, thus multiplying the value of the bot's activity.

The Discovery System 1500 identifies this form of fraud by analyzing the time-series interaction logs associated with a particular visitor to a publisher's website, as well as records of actual purchases.

If the activity did lead to a purchase and was in fact legitimate, then websites 1506, 1507, 1508, 1509, and 1510 can be rewarded for the activity that led to the purchase. This is a significant improvement, as the need for a purchase to procure a reward completely removes the incentive for generating the fraudulent activity.

In this embodiment, when potential fraudulent activity is detected, the Discovery System 1500 generates a report that is reviewed by a reviewer as shown in 1502. If the reviewer identifies the activity as fraudulent, then the reviewer sends an update 1503 to the database of fraudulent entities 1504 that adds a record that identifies the entities involved in the fraudulent activity.

In some embodiments, the Discovery System 1500 may generate update 1503 directly, in cases where there is sufficient confidence in the Discovery System's analysis of this particular scenario, and there is sufficient confidence in the Discovery System's ability to avoid false positives.

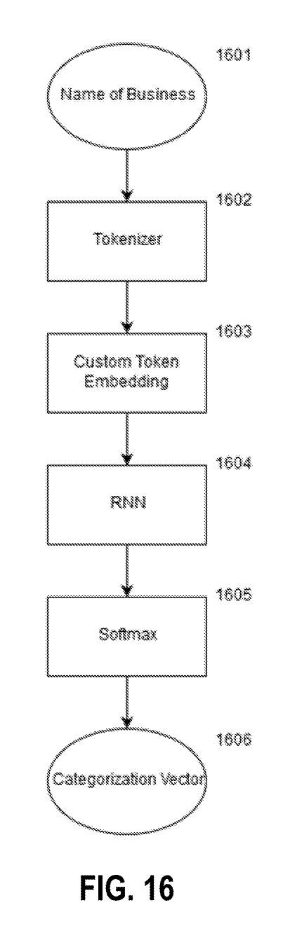

FIG. 16 displays a machine-learning process for categorizing businesses. The name of the business 1601 is turned into a sequence of discrete tokens using a tokenizer 1602, which are converted into numeric vectors using a custom token embedding 1603. The resulting vector sequence is then used as the input to a recurrent neural network 1604, the output of which is processed using a softmax operation 1605, the output of which is a categorization vector 1606, whose elements represent the probability that the business belongs to a particular category.

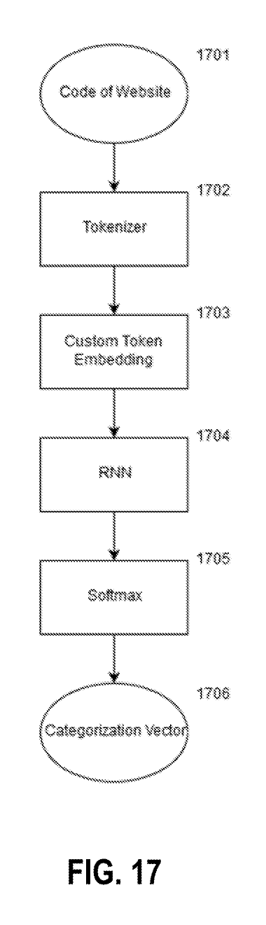

FIG. 17 displays a machine-learning process for categorizing websites using the code of the website. The HTML and Javascript code 1701 used to render the website is turned into a sequence of discrete tokens using a tokenizer 1702. The tokens are converted into numeric vectors using a custom token embedding 1703. The sequence of vectors is then used as the input to a recurrent neural network 1704, the output of which is processed using a softmax operation 1705, the output of which is a categorization vector 1706, whose elements represent the probability that the website belongs to a particular category.

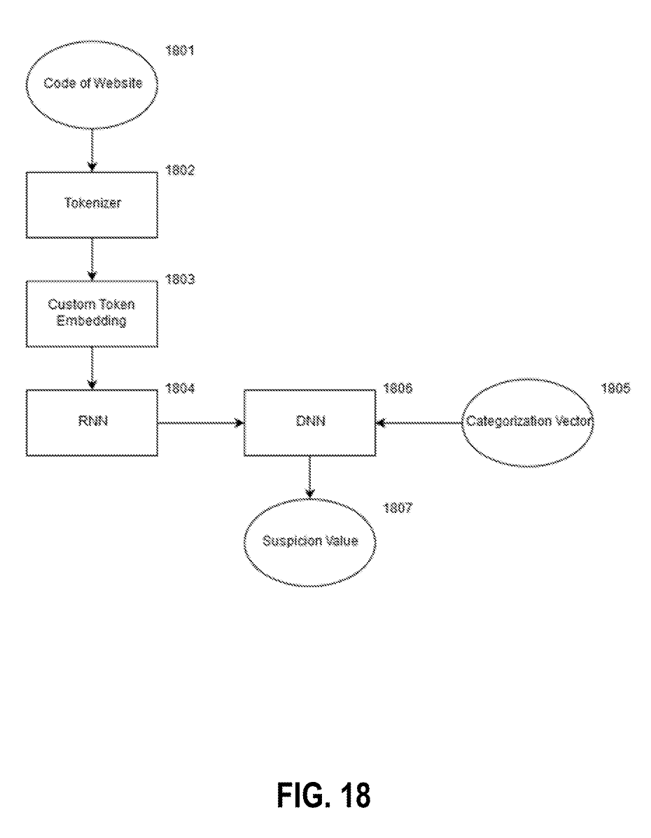

FIG. 18 displays a machine-learning process for identifying suspicious sites based on the HTML code of the website and the category of the website. The HTML and Javascript code 1801 used to render the website is turned into a sequence of discrete tokens using a tokenizer 1802. The tokens are converted into numeric vectors using a custom token embedding 1803. This sequences is processed using a recurrent neural network 1804. The categorization vector associated with this website 1805 is determined using the process displayed in FIG. 17. The output of the RNN and the categorization vector are used as inputs to a dense neural network 1806, the output of which 1807 is a number between 0 and 1 representing the level of suspicion that this site generates.

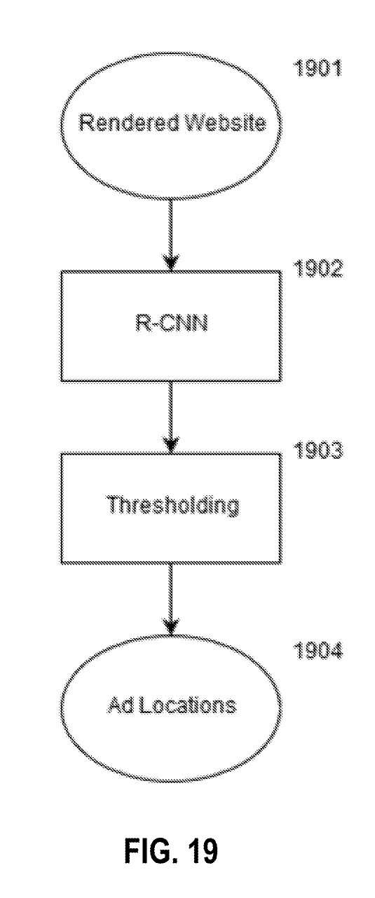

FIG. 19 displays a machine-learning process for counting the number of ads displayed on a website. An image of the rendered website 1901 is used as input to a regional convolutional neural network 1902, whose output is a list of regions that are thought to contain ads, and a confidence score between 0 and 1 for each region. Regions for which the confidence score is below a threshold 1903 are removed. If the number of advertisements in the final list 1904 does not match the expected number as recorded in the advertising database, this may be indicative of display fraud.

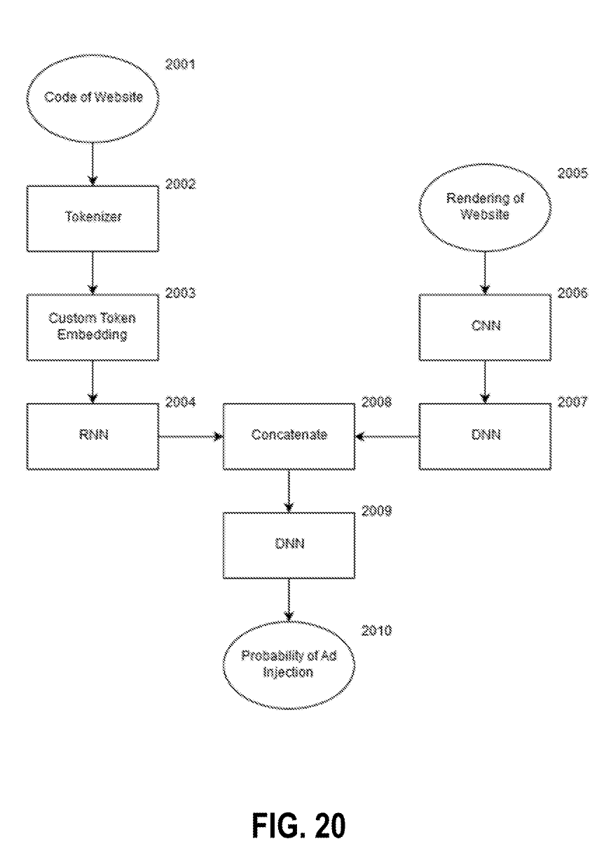

FIG. 20 displays a machine-learning process for identifying ad injection attacks on websites using the HTML code of the website and an image of the website rendered using the HTML code.

The HTML and Javascript code 2001 used to render the website is turned into a sequence of discrete tokens using a tokenizer 2002. The tokens are converted into numeric vectors using a custom token embedding 2003. The vector sequence is used as the input to a recurrent neural network 2004, whose output is a vector representing meaningful features extracted from the code.

In parallel, a rendered image of the website 2005 is processed using a convolutional neural network 2006. The output of the convolutional network is further processed using a dense neural network 2007, whose output is a vector representing meaningful features extracted from the rendering.

In an embodiment, both the code and the rendering are processed. This allows the network to pick up on discrepancies between the two. Example: a common injection vector is cross-site scripting. The injection code might not actually be present in the downloaded HTML, because it's buried in user content that loads late. In that case, examining just the code is insufficient.

The two feature vectors are concatenated lengthwise 2008 and used as the input to another dense neural network 2009, whose output 2010 is a number between 0 and 1 indicating the probability that this website contains ad injection.

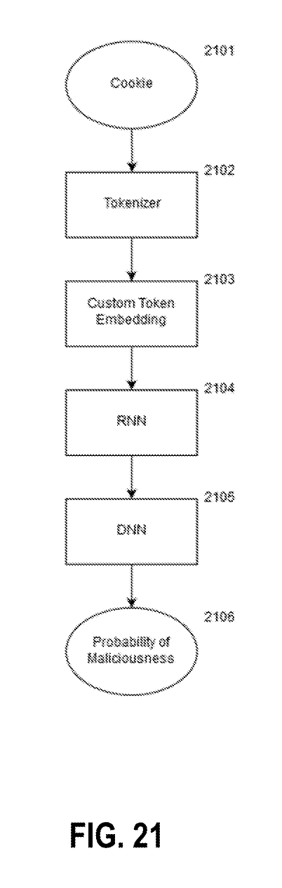

FIG. 21 displays a machine-learning process for identifying malicious cookies loaded by a publisher's website. Examples of malicious cookies include aggressive tracking cookies, and long-lived cookies from malicious affiliate marketers (“cookie stuffing”).

A cookie string 2101 is transformed into a sequence of discrete tokens using a tokenizer 2102. The tokens are then transformed into numeric vectors using a custom token embedding 2103. The sequence of vectors is processed by a recurrent neural network 2104, whose output is further processed by a dense neural network 2105, whose output 2106 is a number between 0 and 1 indicating the probability that this cookie was loaded with malicious intentions.

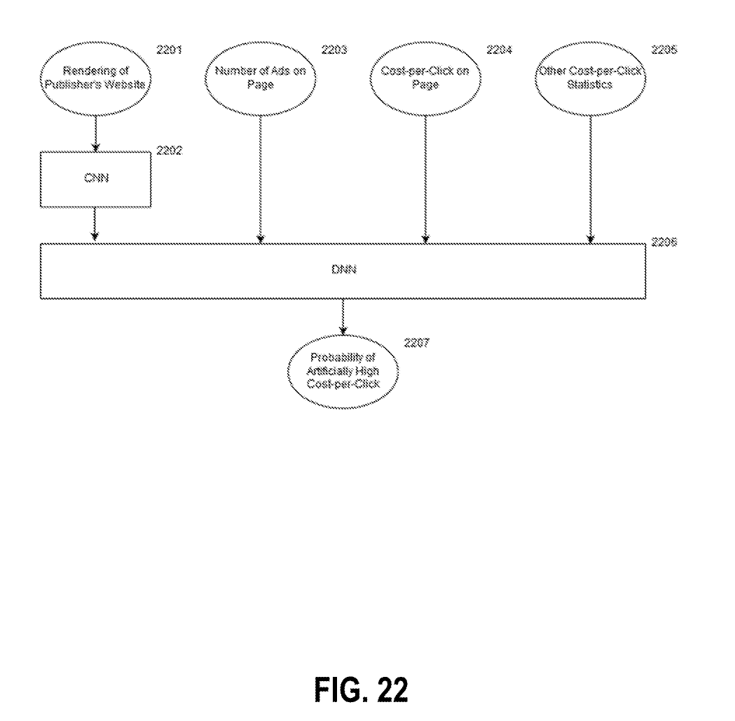

FIG. 22 displays a machine-learning process for identifying pages that target artificially high cost-per-click without providing intrinsic value; for example, sites where there is no content, only ads. Such sites are likely to be generating traffic through click farms or other illegitimate means.

A rendering of the publisher's website 2201 is processed using a convolutional neural network 2202 to extract raw features; the output of this network is used as input to a dense neural network 2206, along with the number of advertisements on the page 2203, as discovered using the process displayed in FIG. 17, as well as the current cost-per-click on the publisher's site 2204, and other cost-per-click statistics 2205, including but not limited to the average cost-per-click on the publisher's website over a prior time period, the minimum, maximum, and average cost-per-click for all websites in the same category as the publisher's website; and the minimum, maximum and average cost-per-click for all publishers. The output 2207 of the dense network is a number between 0 and 1 indicating the probability that this website targets high cost-per-click without generating real value.

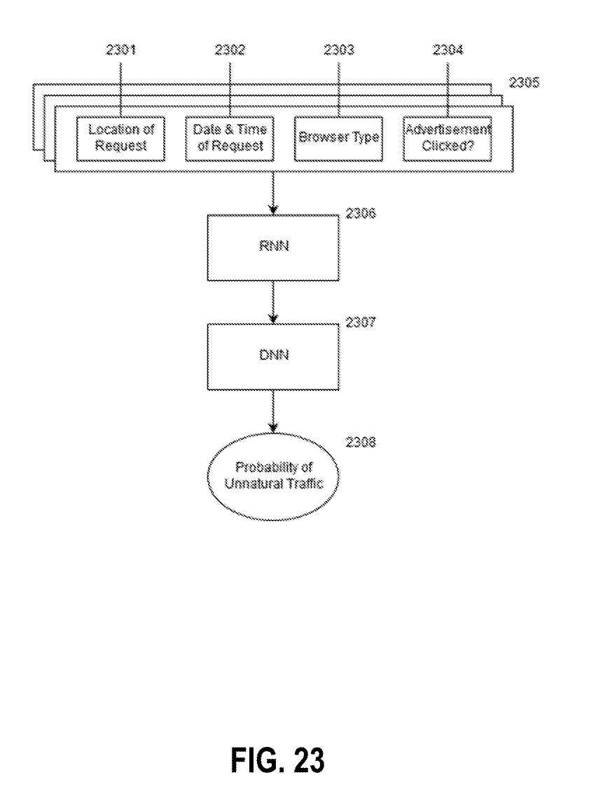

FIG. 23 displays a machine-learning process for identifying fraudulent traffic extension, also known as “traffic sourcing”, wherein a publisher pays for fake traffic to meet the requirements of an advertising campaign or simply to drive up the price of advertisements on the publisher's website.

Details of a particular ad request, including but not limited to the location of origin of the request as determined by IP lookup 2301, the date and time at which the request was made 2302, the type of browser that made the request 2303, and whether or not the advertisement was clicked 2304, are aggregated and placed into a time series 2305. The time series is evaluated by a recurrent neural network 2306, whose output is further processed by a dense neural network 2307, whose output 2308 is a number between 0 and 1 indicating the probability that the traffic recorded in the time series is fraudulent.

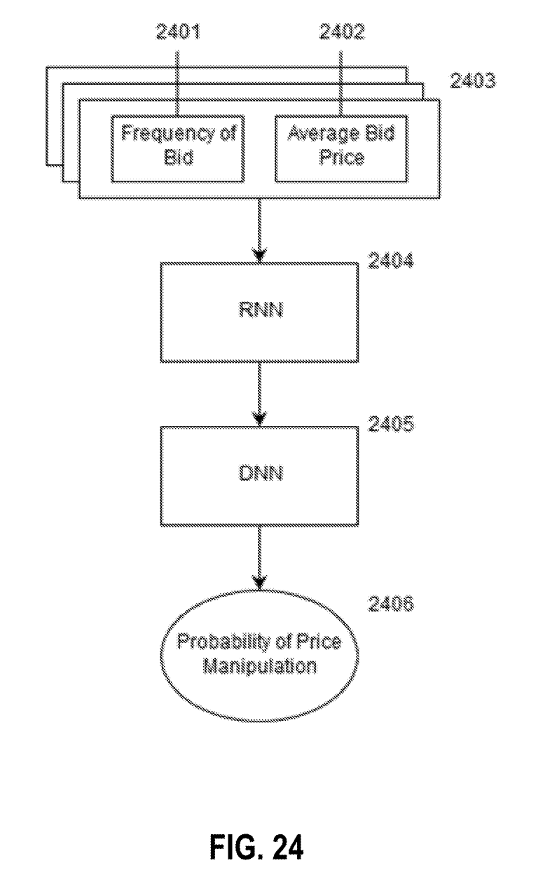

FIG. 24 displays a machine-learning process for identifying price manipulation activity, such as collusion, on an auction-based advertising network. The average bid price 2401 and the frequency of bids 2402 for a particular advertising placement are recorded at regular intervals and merged into a time series 2403. This time series is evaluated by a recurrent neural network 2404, whose output is further processed by a dense neural network 2405, whose output 2406 is a number between 0 and 1 indicating the probability that the activity recorded in the time series represents price manipulation.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

### Example 1: Detection of Fraudulent Traffic

The following is one example embodiment of the invention that does not limit the scope of the claims. In reference to this embodiment, suppose a malicious publisher builds an autonomous system, referred to as a “bot”, to generate traffic on the publisher's website.

In reference to FIG. 1, the bot is programmed to repeatedly access the publisher's website 103 and trigger an advertisement display 115, thus costing the advertiser a display fee. This causes an increase in the cost per click of advertisements displayed on the publisher's platform despite the fact that no real value is being created. In other scenarios, the bot may be programmed to merely visit the site, generating an illusion of traffic to either improve the perceived value of the publisher's website as a marketing opportunity or meet the terms of an advertising contract. This pattern is observable by the Discovery System 100 in the record of transactions on blockchain 101 associated with the public key of the publisher.

In this embodiment of the invention, as the Discovery System processes records on the blockchain, advertisements that meet the following criteria are marked for machine-learning inspection:

1. Advertisements with increasing numbers of transaction records per unit time

2. Advertisements with a high number of transaction records per unit time compared to average for keywords related to the ad.

In reference to FIG. 23, an ad request record time series 2305 is used as input to the recurrent neural network 2306, which in this particular embodiment is chosen to be a long short term memory (LSTM) network. The time series contains a record of ad purchases involving a single publisher, information on which includes in this example: the unique identifier associated with the advertisement displayed, the public key of the advertiser requesting the advertisement, and the amount transferred in tokens (e.g., ADB™ AdBank Token) as part of the transaction, as well as: what country the advertisement was rendered in 2301; the type of browser it was rendered in 2303; and whether the advertisement was clicked on 2304. Categorical data is one-hot encoded.

Table 1 describes a sample record under this scheme. A single sequence consists of an ordered list of 300 of these records.

TABLE 1

| Record Field | Sample Value | Data Type |
|---|---|---|
| Amount Transferred | 0.1234 | 64-bit float |
| Ad was clicked | 1 | Boolean |
| Rendered in Country 1 | 0 | Boolean |
| Rendered in Country 2 | 1 | Boolean |
| . . . | . . . | . . . |
| Rendered in Country N | 0 | Boolean |
| Rendered in Browser 1 | 1 | Boolean |
| Rendered in Browser 2 | 0 | Boolean |
| . . . | . . . | . . . |
| Rendered in Browser M | 0 | Boolean |

In this embodiment, LSTM network 2306 consists of several LSTM layers of width (N+M+3), where N is the number of known countries and M is the number of known browser types. In this embodiment, the densely-connected neural network 2307 consists of one densely-connected layer of the same width, followed by a final densely-connected layer of width 1. Output 2308 is a single value between zero and one, which represents the confidence that this is an instance of fraud. This architecture is shown in more detail in Table 2.

TABLE 2

| Layer Type | Number of Neurons | Activation |
|---|---|---|
| LSTM 1 | N + M + 3 | ReLU |
| . . . | . . . | . . . |
| LSTM X | N + M + 3 | ReLU |
| Dense | N + M + 3 | ReLU |
| Dense | 1 | Sigmoid |

In this particular embodiment, if the computed probability of unnatural or artificial traffic 2308 is above a threshold of 0.99, the sequence is identified as representing malicious activity. The corresponding publisher profile can be added to a data structure storing a list of publisher profiles applied for exclusive filtering.

In order to perform this task, the network is trained on record sequences that are labelled by experts as representing or not representing fraudulent traffic. Fraudulent sequences are labelled as 1, and non-fraudulent sequences are labelled as 0.

The error, or loss, of the network on this task, in this embodiment, is taken to be the squared difference between the prediction and the label. During training, the network's parameters are adjusted to minimize this loss using a known optimization algorithm, which in this embodiment is chosen to be Adaptive Moment Estimation (Adam), in a process which is known as backpropagation.

Training is performed until the mean loss over all samples in an unseen test dataset reduces below 0.01, and is considered successful if the classification error—measured as the percentage of falsely-identified records—is below 0.01.

### Example 2: Detection of Ad Injection

The following is one example embodiment of the invention that does not limit the scope of the claims. In reference to this embodiment, suppose a malicious actor injects advertisements into a legitimate publisher's website, via methods such as cross-site scripting or SQL injection, in order to fraudulently benefit from the legitimate publisher's traffic.

This behavior is detected using both the HTML and Javascript code of the publisher's platform, and images representing the fully rendered platform. These two datasets are processed using feature extraction processes such as those outlined below, which are merged into a single input for classification.

In reference to FIG. 20, image features are extracted using a convolutional neural network (CNN) 2006, which are further processed using a dense neural network (DNN) 2007, the output of which in this embodiment is a feature vector of length 300.

In parallel, the code of the website is split into a sequence of discrete tokens using a known HTML lexer 2002. These tokens are converted into numeric vectors of length 300 using a custom embedding 2003. This embedding is learned using the same techniques as the popular “Word2Vec” embedding, using a corpus of HTML documents including both known fraudulent and known legitimate websites. The output is processed using the recurrent neural network (RNN) 2004, the output of which in this embodiment is a feature vector of length 300.

The RNN 2004 can be modified such that the set of input hybrid website and image features is provided to the centralized fraud detection neural network in the form of a data structure configured to have a number of time series, a number of values per time step, and a number of time steps, and wherein the number of time series, the number of values per time step, and the number of time steps are tunable to modify characteristics of operation of the centralized fraud detection neural network.

The final feature vector used for classification is obtained by concatenating the image feature vector with the token feature vector as shown in 2008, creating a vector of length 300+300=600. This vector is then used as input for a DNN 2009, consisting of 3 rectified linear unit (ReLU) layers of width 600, followed by a single sigmoid layer of width 2. Output 2009 is a single value between zero and one, which represents the confidence that there is advertisement injection present in this example. The amount of concatenation, in some embodiments, can be modified such that a number of concatenations are tuned to maintain a target confidence level.

In this particular embodiment, if the computed probability of the presence of advertisement injection 2009 is above a threshold of 0.99, the sample is identified as representing malicious activity. The corresponding publisher profile can be added to a data structure storing a list of publisher profiles applied for exclusive filtering.

In order to perform this task, the network is trained on HTML document samples that are labelled by experts as containing or not containing injected advertisements. Samples containing injected advertisements are labelled as 1, and others are labelled as 0.

The error, or loss, of the network on this task, in this embodiment, is taken to be the squared difference between the prediction and the label. During training, the network's parameters are adjusted to minimize this loss using a known optimization algorithm, which in this embodiment is chosen to be Adaptive Moment Estimation (Adam), in a process which is known as backpropagation.

Training is performed until the mean loss over all samples in an unseen test dataset reduces below 0.01, and is considered successful if the classification error—measured as the percentage of falsely-identified records—is below 0.01.

### Example 3—Detection of Price Manipulation Activity

The following is one example embodiment of the invention that does not limit the scope of the claims. In reference to this embodiment, suppose a malicious agent wishes to manipulate the price of advertising opportunities on a particular platform by bidding anomalously high on said opportunities. This artificially increases the price of those opportunities for the benefit of the agent. This can be done to either increase the profit of an advertiser, or to reduce the profit of a competitor by driving the price of their ads above competitive levels.

In reference to this embodiment, this behavior is detected using the record of transactions on the distributed ledger. Specifically, in reference to FIG. 24, the frequency of bids over time 2401 and the average bid price over time 2402 are used. These metrics are sampled at regular intervals of one hour, creating a time series 2403. In this particular embodiment, the last 300 samples are used for detection.

In reference to FIG. 24, the time series 2403 is used as the input to a recurrent neural network (RNN) 2404 consisting of 3 layers of width 3. The output of the RNN is used as the input to a dense neural network (DNN) 2405 consisting of 2 rectified linear unit (ReLU) layers of width 3, followed by a sigmoid layer of width 1. The output 2406 is a single value between zero and one, which represents the confidence that this series is an example of price manipulation.

In this particular embodiment, if the computed probability of the presence of price manipulation 2406 is above a threshold of 0.99, the sample is identified as representing malicious activity. In reference to claim 23, the corresponding publisher profile is added to a data structure storing a list of publisher profiles applied for exclusive filtering.

In order to perform this task, the network is trained on record sequences that are labelled by experts as containing or not containing injected advertisements. Samples representing price manipulation are labelled as 1, and others are labelled as 0.

The error, or loss, of the network on this task, in this embodiment, is taken to be the squared difference between the prediction and the label. During training, the network's parameters are adjusted to minimize this loss using a known optimization algorithm, which in this embodiment is chosen to be Adaptive Moment Estimation (Adam), in a process which is known as backpropagation.

Training is performed until the mean loss over all samples in an unseen test dataset reduces below 0.01, and is considered successful if the classification error—measured as the percentage of falsely-identified records—is below 0.01.

What is claimed is:

1. A computing device for advertising fraud discovery including computer memory, the computing device comprising:
a data storage configured for storing one or more data sets representative of a centralized fraud detection neural network;
a processor configured to maintain the neural network stored on the data storage, the neural network comprising an interconnected set of computing nodes adapted as a plurality of layers and a plurality of interconnections between computing nodes of the set of computing nodes, having a set of input computing nodes each representative of a fraud detection feature, interconnection representing a weight between computing nodes indicative of a relationship between the fraud detection features underlying the computing nodes, the fraud detection features including at least a set of website code features, and a set of image features, and an additional set of computing nodes representing a concatenated set of hybrid website and image features;
a first input receiver configured to receive tokenized code segments of a website and to process the tokenized code segments to generate the set of input website code features through monitoring of token co-occurrence;
a second input receiver configured to receive image data representing a full screen view or views presented to a user of the website and to process portions of the received image data to generate a set of input image features and classifications indicative of proportions of the received image data rendering at least two of: graphical advertisement, no graphical advertisement, or a non-functional website;
a third input receiver configured to receive data representing an advertisement that should be displayed on the website; and
a merger layer engine configured to merge the set of input website code features and the set of input image features to generate the concatenated set of hybrid website and image features;
wherein the processor is configured to receive at least the set of website code features, the set of image features, the set of input hybrid website and image features, and the data representing the advertisement that should be displayed on the website and generate a confidence metric representative of a classification conducted by the neural network that the advertisement is loaded and displayed on the website, and that the loading of the website was not originally requested by an automated process.

2. The computing device of claim 1, wherein the fraud detection neural network is configured to maintain one or more computing nodes representative of prior renderings of the advertisement as a first set of additional fraud detection features;
wherein the one or more computing nodes representative of the prior displays of the advertisement have weighted interconnections representative of one or more repetitive temporal loading patterns; and
wherein the one or more computing nodes representative of the prior displays of the advertisement are utilized in the generation of the confidence metric such that a presence of the one or more repetitive temporal loading patterns modifies the generated confidence metric.

3. The computing device of claim 2, wherein responsive to any one of the weighted interconnections representative of the one or more repetitive temporal loading patterns being greater than a pre-defined threshold, the processor records the one or more repetitive temporal loading patterns having weighted interconnections greater than the pre-defined threshold on the data storage.

4. The computing device of claim 1, wherein the fraud detection neural network is configured to maintain one or more computing nodes representative of prior prices of the advertisement as a second set of additional fraud detection features;
wherein the one or more computing nodes representative of the prior prices of the advertisement have weighted interconnections representative of one or more repetitive temporal pricing patterns; and
wherein the one or more computing nodes representative of the prior displays of the advertisement are utilized in the generation of the confidence metric such that a presence of the one or more repetitive temporal pricing patterns modifies the generated confidence metric.

5. The computing device of claim 4, wherein responsive to any one of the weighted interconnections representative of the one or more repetitive temporal pricing patterns being greater than a pre-defined threshold, the processor records the one or more repetitive temporal pricing patterns having weighted interconnections greater than the pre-defined threshold on the data storage.

6. The computing device of claim 1, wherein the set of input hybrid website and image features are generated through one or more concatenations of individual input website code features of the set of input website code features with individual input image features of the set of input image features.

7. The computing device of claim 6, wherein the set of input hybrid website and image features further include one or more concatenations of prior price features and one or more concatenations of prior website rendering features; and
wherein a number of the one or more concatenations is iteratively tuned utilizing a feedback loop to maintain a target confidence level.

8. The computing device of claim 7, wherein the target confidence level is established based on a confusion matrix derived from training the fraud detection neural network on a training dataset, the confusion matrix including matrix values indicative of at least an expected probability of false positive, false negative, true positive, and true negative given the training dataset and the input feature set.

9. The computing device of claim 1, wherein the centralized fraud detection neural network is a recurrent neural network; and
wherein the set of input hybrid website and image features is provided to the centralized fraud detection neural network in the form of a data structure configured to have a number of time series, a number of values per time step, and a number of time steps, and wherein the number of time series, the number of values per time step, and the number of time steps are tunable to modify characteristics of operation of the centralized fraud detection neural network.

10. The computing device of claim 1, wherein the set of input image features include at least one of pixel colors, blob detection, edge detection, or corner detection.

11. The computing device of claim 1, wherein the neural network includes at least a LSTM model for classifying the set of input website code features.

12. The computing device of claim 1, wherein the neural network includes at least a CNN configured for image reshaping for classifying the set of input image features.

13. The computing device of claim 1, wherein the computing device is coupled to a distributed set of computing systems, each maintaining a cryptographic distributed ledger in accordance with a consensus mechanism for propagating and updating the cryptographic distributed ledger, the cryptographic distributed ledger storing records of advertising purchase transactions between advertising purchasing parties and advertising publishing parties and one or more data sets representative of the advertisement that should be displayed on the website;
wherein transactions on the cryptographic distributed ledger are identified as malicious or non-malicious through provisioning of the one or more data sets representative of the advertisement and one or more data sets representative of the website as inputs into the arbitration mechanism.

14. The computing device of claim 13, wherein identification of transactions as malicious or non-malicious occurs when the confidence metric is greater than a pre-defined confidence threshold.

15. The computing device of claim 13, wherein identification of transactions as malicious or non-malicious occurs when the confidence metric is greater than a pre-defined confidence threshold; and
wherein a secondary manual arbitration mechanism is utilized as an arbitration mechanism when the confidence metric is equal to or less than the pre-defined confidence threshold.

16. The computing device of claim 13, wherein the records stored on the cryptographic distributed ledger include data sets including at least one of a string identifying what country the advertisement was rendered, a string identifying a type of browser, a string identifying a type of operating system, a string indicating an operating system version, a string indicating product type, a string indicating a device manufacturer, a string indicating a web layout type; and
wherein the data sets are captured temporally proximate to when the advertisement was purchased and subsequently rendered.

17. The computing device of claim 13, wherein the records stored on the cryptographic distributed ledger further include the set of website code features and the set of image features captured on transactions relating to the advertisement by other users.

18. The computing device of claim 13, wherein upon a positive identification of a malicious advertisement, a corresponding publisher profile is added to a data structure storing a list of publisher profiles applied for exclusive filtering; and
wherein the distributed set of computing systems utilize an acceptance protocol for gatekeeping acceptance of new blocks representing the advertising purchase transactions, the acceptance protocol adapted to automatically decline the acceptance of new blocks associated with any publisher profile residing on the list of publisher profiles.

19. A method for conducting advertising fraud discovery, the method comprising:
storing one or more data sets representative of a centralized fraud detection neural network;
maintaining the centralized fraud detection neural network stored on the data storage, the neural network comprising an interconnected set of computing nodes adapted as a plurality of layers and a plurality of interconnections between computing nodes of the set of computing nodes, having a set of input computing nodes each representative of a fraud detection feature, interconnection representing a weight between computing nodes indicative of a relationship between the fraud detection features underlying the computing nodes, the fraud detection features including at least a set of website code features, and a set of image features, and an additional set of computing nodes representing a concatenated set of hybrid website and image features;
receiving tokenized code segments of a website;
processing the tokenized code segments to generate the set of input website code features through monitoring of token co-occurrence;
receiving image data representing a full screen view or views presented to a user of the website and to process portions of the received image data to generate a set of input image features and classifications indicative of proportions of the received image data rendering at least two of: graphical advertisement, no graphical advertisement, or a non-functional website;
receiving data representing an advertisement that should be displayed on the website; and
merging the set of input website code features and the set of input image features to generate the concatenated set of hybrid website and image features; and
generating a confidence metric representative of a classification conducted by the neural network that the advertisement is loaded and displayed on the website based at least on the set of website code features, the set of image features, the set of input hybrid website and image features, and the data representing the advertisement that should be displayed on the website, and that the loading of the website was not originally requested by an automated process.

20. A computer readable medium, storing machine interpretable instructions, which when executed by a processor, cause the processor to perform a method for conducting advertising fraud discovery, the method comprising:
storing one or more data sets representative of a centralized fraud detection neural network;
maintaining the centralized fraud detection neural network stored on the data storage, the neural network comprising an interconnected set of computing nodes adapted as a plurality of layers and a plurality of interconnections between computing nodes of the set of computing nodes, having a set of input computing nodes each representative of a fraud detection feature, interconnection representing a weight between computing nodes indicative of a relationship between the fraud detection features underlying the computing nodes, the fraud detection features including at least a set of website code features, and a set of image features, and an additional set of computing nodes representing a concatenated set of hybrid website and image features;
receiving tokenized code segments of a website;
processing the tokenized code segments to generate the set of input website code features through monitoring of token co-occurrence;
receiving image data representing a full screen view or views presented to a user of the website and to process portions of the received image data to generate a set of input image features and classifications indicative of proportions of the received image data rendering at least two of: graphical advertisement, no graphical advertisement, or a non-functional website;
receiving data representing an advertisement that should be displayed on the website; and
merging the set of input website code features and the set of input image features to generate the concatenated set of hybrid website and image features; and
generating a confidence metric representative of a classification conducted by the neural network that the advertisement is loaded and displayed on the website based at least on the set of website code features, the set of image features, the set of input hybrid website and image features, and the data representing the advertisement that should be displayed on the website, and that the loading of the website was not originally requested by an automated process.
